(19) United States
(12) Patent Application Publication
(10) Pub. No.: US 2017/0329397 A1
(43) Pub. Date: Nov. 16, 2017

(54) SYSTEMS AND METHODS FOR NAVIGATING A MEDIA GUIDANCE APPLICATION USING GAZE CONTROL

(71) Applicant: Rovi Guides, Inc., San Carlos, CA (US)

(72) Inventor: Edison Lin, Menlo Park, CA (US)

(21) Appl. No.: 15/153,019

(22) Filed: May 12, 2016

(51) Int. Cl. G06F 3/01; G06F 3/0482; G06F 3/0484; G06F 3/16

(52) U.S. Cl. CPC G06F 3/013; G06F 3/167; G06F 3/0482; G06F 3/04845

(57) ABSTRACT

Systems and methods are described herein for navigating a media guidance application using gaze control. A media guidance application may have an option to transform the display into a gaze-control mode, which may, for example, change the size, shape, and/or location of certain indicators on the screen to make them easier to select using gaze control. The media guidance application may determine and rank the indicators that are most likely to be selected by the user. Higher-ranked indicators may be relatively larger in size and placed closer to the center of a displayed media guidance screen, while lower-ranked indicators may be relatively smaller and placed closer to the periphery of the displayed media guidance screen. The indicators may correspond to, among others, listings for media assets, categories of media asserts, or media guidance options/commands.

### BACKGROUND

Consumers use a variety of user devices to consume media content, including, for example, personal computers, tablets, and smart phones, among others. Some of these user devices may include image recognition hardware, such as cameras, which allow the device to receive user inputs by tracking a gaze and/or eye movement of the user. However, typical media guidance applications may display selectable indicators for media assets and other media options with sizes and shapes that are not optimized for gaze control. For instance, due to the relatively low accuracy of gaze inputs, it may be difficult for a user to accurately select a small program listing on a typical grid guide. As such, the user may not be able to efficiently navigate a typical media guidance application using gaze control.

### SUMMARY

Accordingly, systems and methods are described herein for navigating a media guidance application using gaze control. A media guidance application may have an option to transform the display into a gaze-control mode, which may, for example, change the size and shape of certain indicators on the screen to make them easier to select using gaze control. As used herein, “gaze” refers to a location where the user is currently looking or that corresponds to a location or movement of the user's eyes. “Gaze control” refers to receiving user inputs by, at least in part, tracking a user's gaze and/or eye-movement.

As an illustrative example, the media guidance application may change the size, shape, and location of certain selectable indicators to make them easier to select using gaze control. The media guidance application may determine and rank the indicators that are most likely to be selected by the user. Higher-ranked indicators may be relatively larger in size and placed closer to the center of a displayed media guidance screen, while lower-ranked indicators may be relatively smaller and placed closer to the periphery of the displayed media guidance screen. The indicators may correspond to, among others, listings for media assets, categories of media asserts, or media guidance options/commands.

The gaze-control mode may be dynamic such that the indicators move and change in size and shape if the user does not select one of the indicators. For example, the top-ranked indicator by popularity, if not selected, may slowly get smaller and drift to the periphery to allow the second-ranked indicator to get larger and drift toward the center of the media guidance screen. The user may select an indicator by, for example, resting his/her gaze on an indicator for a set period of time, or by resting his/her gaze on an indicator in combination with a second input, such as a voice input or a button press on a remote control.

According to some aspects, a media guidance application may receive a user input to transform the media guidance screen to utilize gaze control. This input may be any suitable user input, including a button press on a user input device (such as a remote control, keyboard, mouse, etc.), a voice input, or a gaze input. The media guidance screen may comprise a plurality of indicators for media assets, wherein a first indicator of the plurality of indicators has a first size. As an illustrative example, the media guidance screen may be a grid guide, such as the guide depicted in FIG. 3, with each cell of the grid guide corresponding to a selectable indicator having a particular size and shape.

In response to the user input to transform the media guidance screen to utilize gaze control, the media guidance application may retrieve from a database, for each of the plurality of indicators, popularity metadata corresponding to a popularity of a media asset associated with a respective indicator. The popularity metadata may comprise any data that may be used to calculate the popularity of a particular indicator, either with respect to the user or with respect to a plurality of users. For example, the popularity metadata may include ratings data from the user or from a third party, media asset viewing history of the user, media asset viewing history of a plurality of users, and media asset preferences of the user.

In some embodiments, the media guidance application may calculate “relative” popularity that is targeted to a particular user. For example, the media guidance application may access a user profile of the particular user and extract media preference information of the user to determine which media assets the user may be likely to select. The user profile information may include genre preferences, favorite programs, favorite time slots, ratings/feedback information, viewing history, and media asset actions/selections, among others. In some embodiments, the media guidance application may calculate “absolute” popularity with respect to a plurality of users. For example, the media guidance application may access popularity metadata that indicates the genre preferences, favorite programs, favorite time slots, ratings/feedback information, viewing history, and/or media asset actions/selections of a plurality of viewers. In this manner, the media guidance application may determine the most popular programs among a group of users.

In some embodiments, the media guidance application may combine the “relative” popularity and the “absolute” popularity calculations in order to determine which indicators to present to the user in gaze control mode. As an illustrative example, the media guidance application may determine that the SUPER BOWL is a popular program based on the number of currently active viewers, number of viewers who set a reminder for the program, number of viewers who set a recording for the program, and the amount of activity on social media networks that mention the SUPER BOWL. The media guidance application may also determine from a user's profile that they prefer sports programs and football in particular. Based on these determinations, the media guidance application may generate for display an indicator for the SUPER BOWL in gaze-control mode, wherein the indicator is relatively large and placed towards the center of the media guidance screen to indicate its relatively high popularity and high probability of selection by the user.

The media guidance application may calculate for each of the plurality of indicators, based on the retrieved popularity metadata, a probability that a user will select the respective indicator. In some embodiments, the media guidance application may calculate the probability by calculating a numerical score for each of the plurality of indicators based on the retrieved popularity metadata. For example, the media guidance application may divide the popularity metadata into one or more components, such as prior viewing history and selections, third-party ratings data, user preferences, and user ratings and feedback data. For each component, the media guidance application may calculate a respective numerical component score.

In some embodiments, the media guidance application may assign points to certain data that are indicated in the popularity metadata. For example, the media guidance application may assign a certain number of points to media assets that the user has previously viewed. The media guidance application may also assign points to certain user actions with respect to media assets, such as requests for information, setting reminders, setting recordings, or selections for viewing. As another example, the media guidance application may retrieve a critic rating as a percentage score from a remote database (such as a website) and assign the retrieved percentage score as the component score for the component “third-party ratings.” The media guidance application may combine the component scores using any suitable calculation, such as an average or weighted average in order to output a total percentage that represents a likelihood that the user will select the respective indicator. Before combining the component scores, the media guidance application may normalize each of the component scores. For example, the media guidance application may sum the component scores and divide each component score by the sum in order to obtain normalized component scores.

In some embodiments, the indicators will correspond to selectable options of the media guidance application. For example, the indicator may represent an option to see only listings for movies or listings for sports. In such embodiments, the media guidance application may calculate the probability that the user will select the respective option based on how often the user has selected that option in the past, in conjunction with any other suitable popularity metadata as discussed above.

Based on the calculated probabilities for the indicators, the media guidance application may adjust the size of one or more indicators on a generated media guidance screen. In some embodiments, the media guidance application may also adjust the shape and location of the one or more indicators. In some embodiments, the media guidance screen may remove some of the indicators that were displayed in the grid guide in order to provide additional space for the remaining indicators in gaze control mode. As an illustrative example, the media guidance application may select the top five most probable indicators to be selected by the user and adjust their size to reflect their respective probabilities. That is, the higher-probability indicators will be relatively larger than the lower-probability indicators. The shape of the indicators may also be changed to be circles or bubbles, and the location of the indicators may also reflect their respective probabilities, such that higher-probability indicators are located closer to the center of the displayed screen, while lower-probability indicators are located towards the periphery of the displayed screen.

In gaze control mode, the media guidance application may receive a selection of an indicator using eye-tracking hardware, such as a camera or cameras. The media guidance application may use the eye-tracking hardware, in conjunction with suitable image recognition software, to track the eye movement of the user and determine a point on the displayed media guidance screen corresponding to the user's gaze.

The media guidance application may receive the user selection in a number of ways. For instance, the media guidance application may detect the gaze of the user on the first indicator, and subsequent to detecting the gaze of the user on the first indicator, determine that a period of time has passed. In response to the period of time passing, the media guidance application may select the first indicator.

In some embodiments, the media guidance application may detect the gaze of the user on the first indicator, and subsequent to detecting the gaze of the user on the first indicator, may receive a voice command, button push, or other input from a user input device while the gaze of the user is on the first indicator. In response to the voice command, button push, or other input from the user input device, the media guidance application may select the first indicator.

The gaze control mode may dynamically change, such that the displayed indicators change size, shape, and/or location as time elapses. For example, the media guidance application may track the gaze of the user using the eye-tracking hardware and determine that the gaze of the user has not stayed on one of the plurality of indicators for a period of time. In response to determining that the gaze of the user has not stayed on one of the plurality of indicators for the period of time, the media guidance application may adjust the size of the first indicator from the second size to a third size that is different than the second size.

As an illustrative example, as time elapses, some bubbles displayed near the center of the displayed media guidance screen may slowly get smaller and drift towards the periphery of the screen, while an indicator near the periphery may slowly get larger and drift towards the center of the screen. In some embodiments, some indicators may disappear altogether and be removed from the generated display screen, while some new indicators may be displayed as time elapses. In this manner, the gaze control screen may constantly change to present new options to the user if the user is not selecting any of the currently displayed indicators.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media guidance screen utilizing gaze control in accessing media content in accordance with some embodiments of the disclosure;

FIG. 2 shows an illustrative media guidance screen utilizing gaze control in accessing media content in accordance with some embodiments of the disclosure;

FIG. 3 shows an illustrative media guidance screen utilizing gaze control in accessing media content in accordance with some embodiments of the disclosure;

FIG. 4 shows an illustrative media guidance screen utilizing gaze control in accessing media content in accordance with some embodiments of the disclosure;

FIG. 5 shows an illustrative media guidance screen utilizing gaze control in accessing media content in accordance with some embodiments of the disclosure;

FIG. 6 shows an illustrative example of a display screen for use in accessing media content in accordance with some embodiments of the disclosure;

FIG. 7 shows another illustrative example of a display screen used to access media content in accordance with some embodiments of the disclosure;

FIG. 8 is a block diagram of an illustrative user equipment device in accordance with some embodiments of the disclosure;

FIG. 9 is a block diagram of an illustrative media system in accordance with some embodiments of the disclosure;

FIG. 10 is a flowchart of illustrative steps for navigating a media guidance application using gaze control in accordance with some embodiments of the disclosure;

FIG. 11 depicts illustrative pseudocode for utilizing gaze control in a media guidance application in accordance with some embodiments of the disclosure; and

FIG. 12 is a flowchart of illustrative steps for navigating a media guidance application using gaze control in accordance with some embodiments of the disclosure.

### DETAILED DESCRIPTION

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), on-demand information, blogs, websites, and any other type of guidance data that is helpful for a user to navigate among and locate desired content selections.

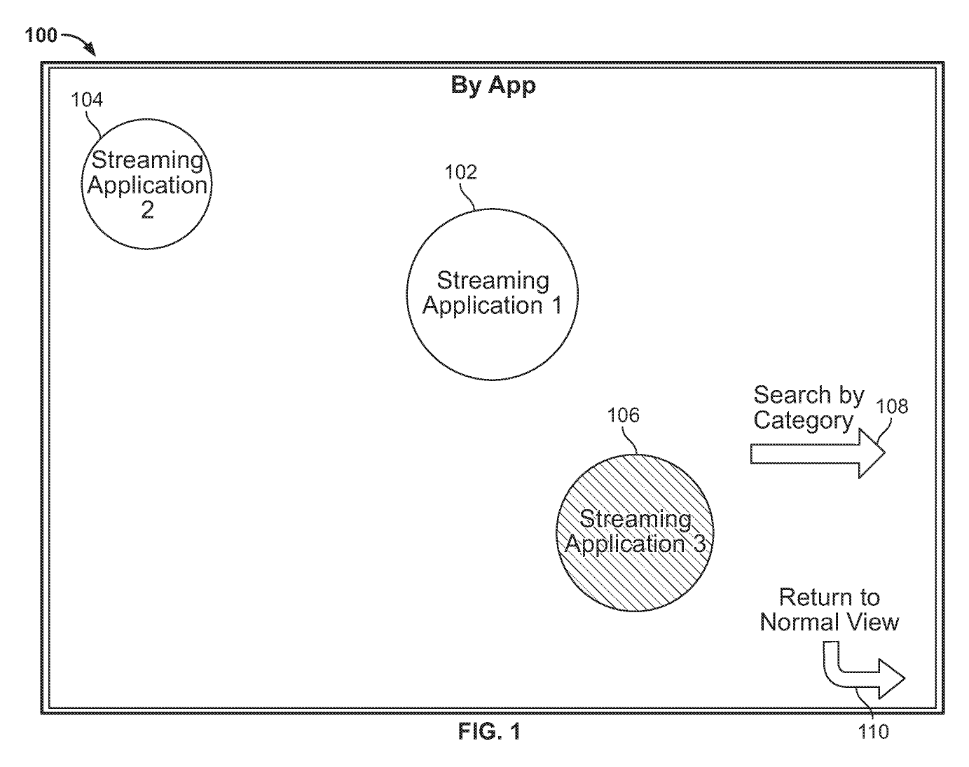

FIG. 1 shows an illustrative media guidance screen 100 utilizing gaze control in accessing media content in accordance with some embodiments of the disclosure. Media guidance screen 100 includes indicators 102 to 106, search by category button 108, and return button 110. It will be understood that media guidance screen 100 is provided for illustrative purposes only, and that other arrangements, orientations, indicators, and configurations are contemplated.

Each of the indicators 102-106 may be depicted as a circle with a particular radius, with indicator 102 having the largest radius and indicator 104 having the smallest radius. It will be understood that each of the indicators 102 to 106 may represent individual media assets, media applications, media categories, media guidance options, or other selection media options. In the illustrative example depicted in FIG. 1, the indicators 102 to 106 may represent media applications that may be launched upon selection by the user. Indicator 102, corresponding to a first media streaming application, may represent the indicator with the highest probability of being selected by the user, as calculated by the media guidance application according to the methods described herein. As such, it may have the largest radius of the indicators 102-106 and be located near the center of the displayed screen 100. In contrast, the indicator 104, corresponding to a second media streaming application may correspond to the indicator with the lowest probability of being selected, and thus may have the smallest radius of the indicators 102-106 and be located near the periphery of the displayed screen 100. The media guidance screen may also track the gaze of the user and highlight an indicator when it detects that the gaze of the user is located on a particular indicator. For example, as depicted in FIG. 1, the indicator 106, corresponding to a third media streaming application may be highlighted when the media guidance application detects that the gaze of the user is resting on the indictor 106.

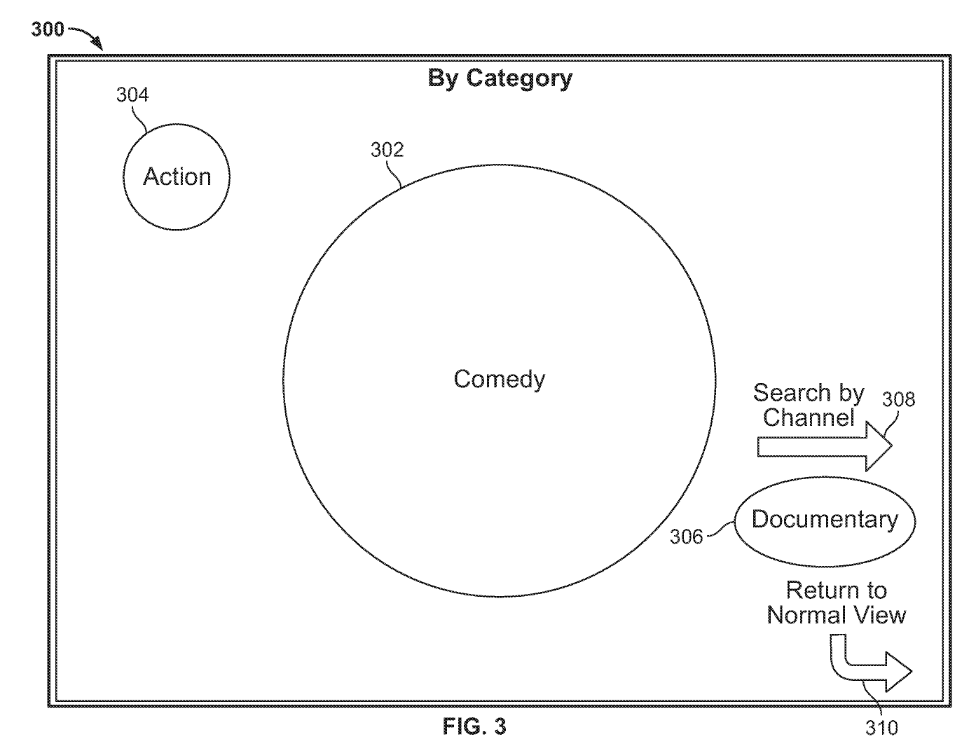

The media guidance screen 100 may dynamically change as time elapses without a user selection of an indicator. For example, as time elapses, the indicator 102 may slowly drift to an edge of the screen 100 and gradually reduce the radius. Concurrently, the indicator 106 may increase in radius and slowly drift towards the center of the screen 100 to occupy the space that was previously occupied by the indicator 102. In this manner, the media guidance screen may suggest a first indicator by placing it near the center of the screen, and suggest other indicators as time elapses by changing the size, shape, and location of the indicators over time. In some embodiments, the media guidance application may calculate the probability of each of the displayed indicators 102-106 on an ongoing or continuous basis according to the methods described herein. For example, the calculation may incorporate a time component that automatically reduces the probability of a respective indicator as time elapses. The media guidance application may adjust the size, shape, and/or location of the indicators on an ongoing basis according to the current probability of the indicator. The user may select button 110 to exit gaze control mode and to return to the previous view, such as a traditional grid guide. The user may select button 108 to go to a different gaze control screen, such as the screen depicted in FIG. 3, discussed herein.

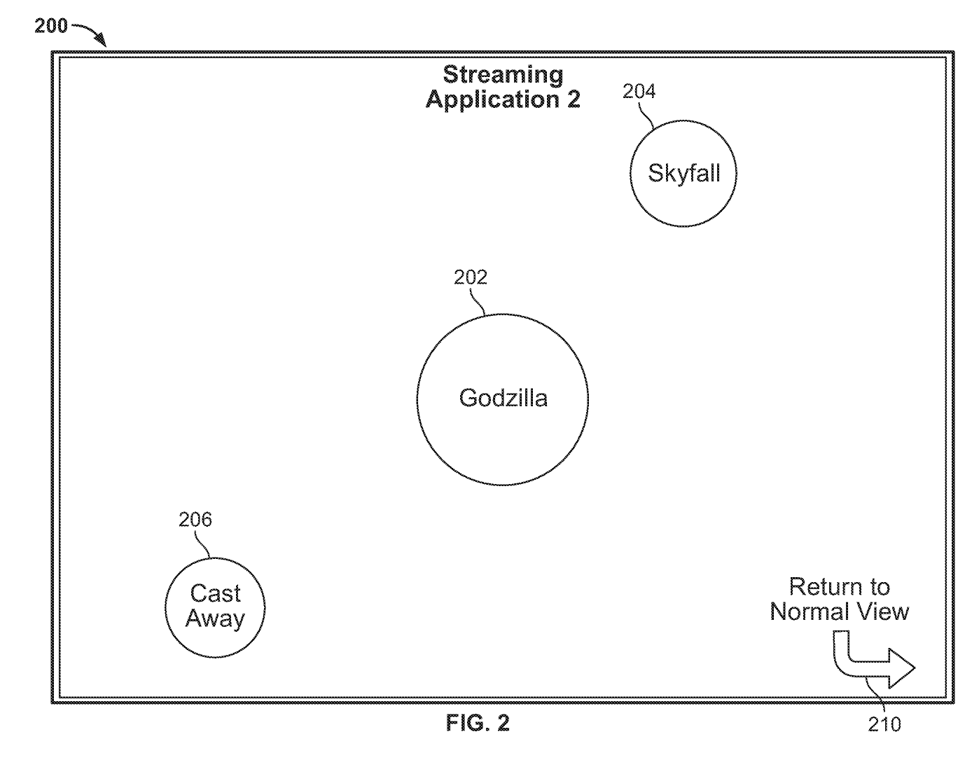

FIG. 2 shows another illustrative media guidance screen 200 utilizing gaze control in accordance with some embodiments of the disclosure. Media guidance screen 200 includes indicators 202 to 206 and return button 210. It will be understood that media guidance screen 200 is provided for illustrative purposes only, and that other arrangements, orientations, indicators, and configurations are contemplated.

In some embodiments, media guidance screen 200 may be a screen that is generated in response to a user selecting indicator 104 corresponding to the second media streaming application depicted in FIG. 1. In response to the user's selection of indicator 104, the media guidance screen may generate new indicators 202-206 that represent media assets provided by the second media streaming application. As with indicators 102-106, the indicators 202-206 may be generated based on a probability that the user will select the respective indicator. The size, shape, and location of the indicators 202-206 may be based on the calculated probabilities. The user may select button 110 to exit gaze control mode and to return to the previous view, such as a traditional grid guide.

FIG. 3 shows an illustrative media guidance screen 300 utilizing gaze control in accessing media content in accordance with some embodiments of the disclosure. Media guidance screen 300 includes indicators 302 to 306, search by channel 308, and return button 310. It will be understood that media guidance screen 300 is provided for illustrative purposes only, and that other arrangements, orientations, indicators, and configurations are contemplated.

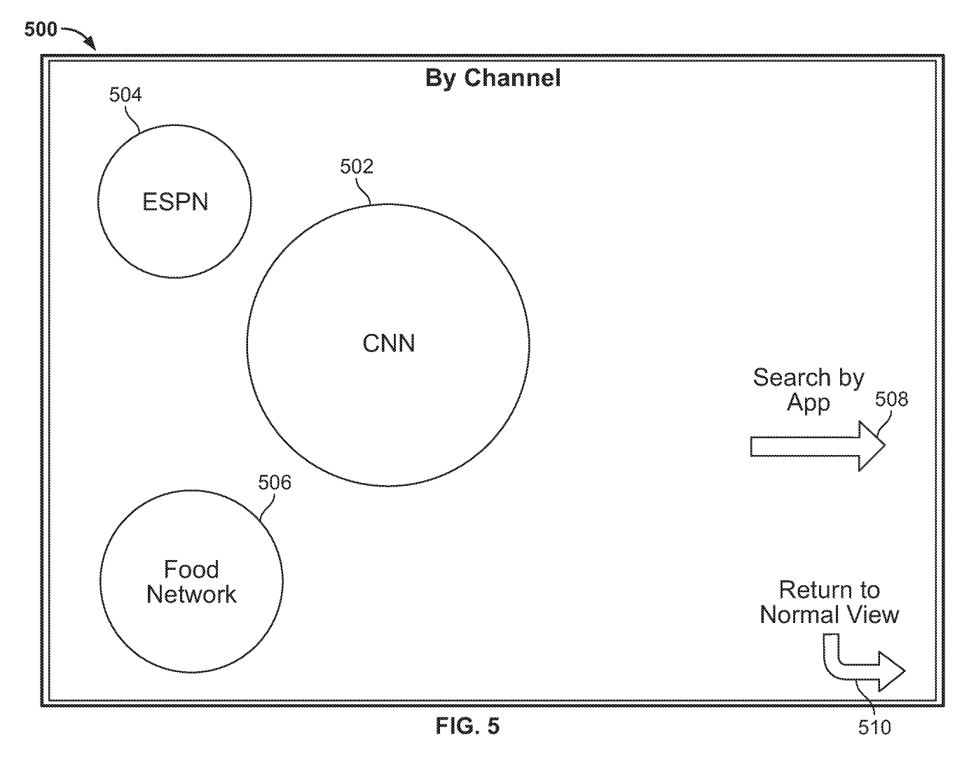

In some embodiments, media guidance screen 300 may be a screen that is generated in response to a user selecting button 108 “search by category” depicted in FIG. 1. For example, in response to the user selecting button 108, the media guidance application may generate new indicators 302 to 306 that represent categories/genres of media assets. In some embodiments, media guidance screen may be generated for display in response to a user input to transform the media guidance screen to gaze control mode. As with indicators 102-106 depicted in FIG. 1, the indicators 302-306 may be generated based on a probability that the user will select the respective indicator. The size, shape, and location of the indicators 302 to 306 may be based on the calculated probabilities. The user may select button 310 to exit gaze control mode and to return to a previous view, such as a traditional grid guide. The user may select button 308 “search by channel” to navigate to a different gaze control screen, such as the screen depicted in FIG. 5, discussed herein.

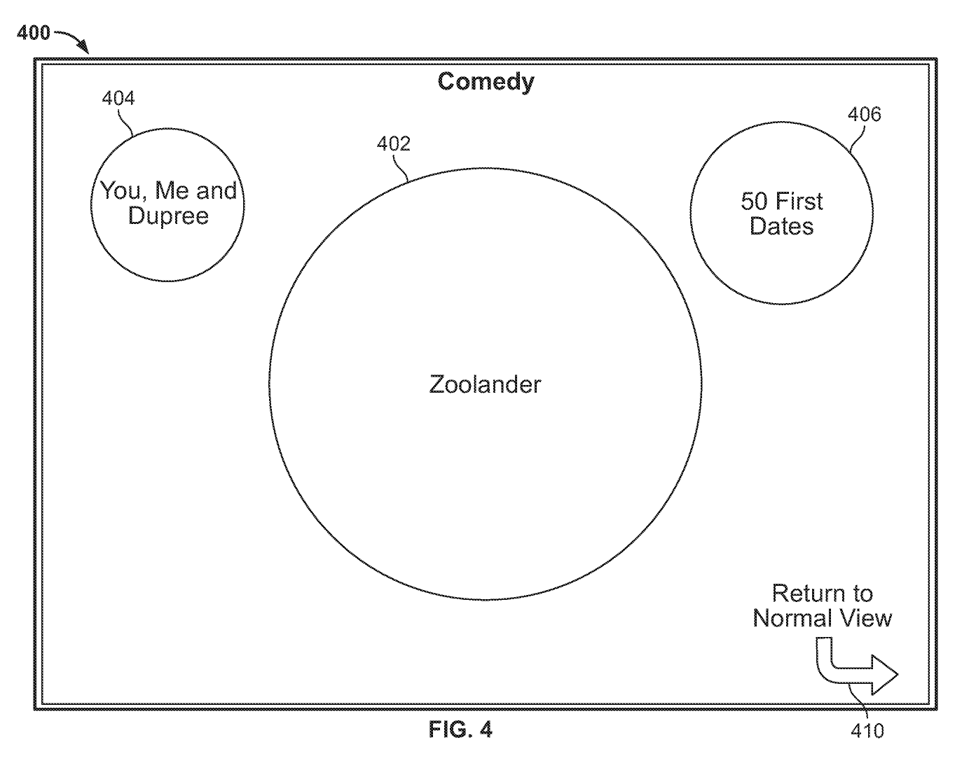

FIG. 4 shows an illustrative media guidance screen 400 utilizing gaze control in accessing media content in accordance with some embodiments of the disclosure. Media guidance screen 400 includes indicators 402 to 406 and return button 410. It will be understood that media guidance screen 400 is provided for illustrative purposes only, and that other arrangements, orientations, indicators, and configurations are contemplated.

In some embodiments, media guidance screen 400 may be a screen that is generated in response to a user selecting indicator 302 “Comedy” depicted in FIG. 3. In response to the user's selection of indicator 302, the media guidance application may generate new indicators 402-406 that represent media assets in the “comedy” genre. As with indicators 102-106, the indicators 402-406 may be generated based on a probability that the user will select the respective indicator. The size, shape, and location of the indicators 402-406 may be based on the calculated probabilities. The user may select button 410 to exit gaze control mode and to return to the previous view, such as a traditional grid guide.

FIG. 5 shows an illustrative media guidance screen 500 utilizing gaze control in accessing media content in accordance with some embodiments of the disclosure. Media guidance screen 500 includes indicators 502 to 506, search by app button 508, and return button 510. It will be understood that media guidance screen 500 is provided for illustrative purposes only, and that other arrangements, orientations, indicators, and configurations are contemplated.

In some embodiments, media guidance screen 500 may be a screen that is generated in response to a user selecting button 308 “search by channel” depicted in FIG. 3. For example, in response to the user selecting button 308, the media guidance application may generate new indicators 502 to 506 that represent individual channels or sources for media assets. In some embodiments, media guidance screen may be generated for display in response to a user input to transform the media guidance screen to gaze control mode. As with indicators 102-106 depicted in FIG. 1, the indicators 502-506 may be generated based on a probability that the user will select the respective indicator. The size, shape, and location of the indicators 502 to 506 may be based on the calculated probabilities. The user may select button 510 to exit gaze control mode and to return to a previous view, such as a traditional grid guide. The user may select button 508 “search by app” to navigate to a different gaze control screen, such as the screen depicted in FIG. 1, discussed herein.

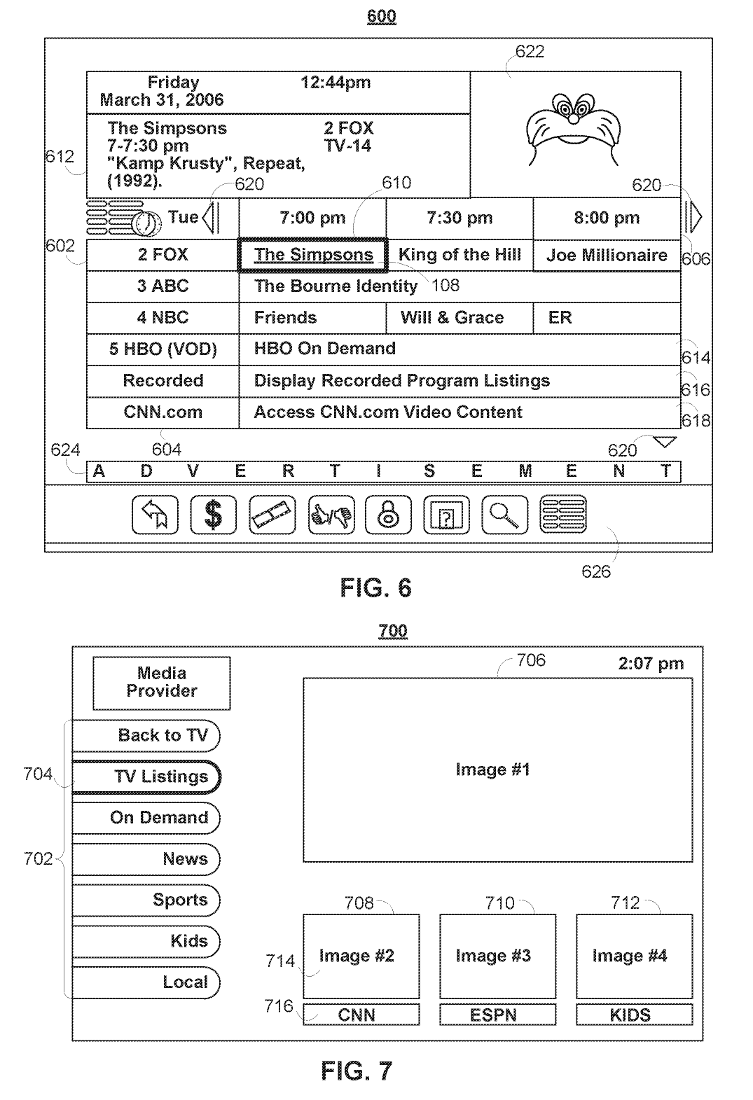

FIGS. 6-7 show illustrative display screens that may be used to provide media guidance data. The display screens shown in FIGS. 6-7 may be implemented on any suitable user equipment device or platform. While the displays of FIGS. 6-7 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 6 shows illustrative grid of a program listings display 600 arranged by time and channel that also enables access to different types of content in a single display. Display 600 may include grid 602 with: (1) a column of channel/content type identifiers 604, where each channel/content type identifier (which is a cell in the column) identifies a different channel or content type available; and (2) a row of time identifiers 606, where each time identifier (which is a cell in the row) identifies a time block of programming. Grid 602 also includes cells of program listings, such as program listing 608, where each listing provides the title of the program provided on the listing's associated channel and time. With a user input device, a user can select program listings by moving highlight region 610. Information relating to the program listing selected by highlight region 610 may be provided in program information region 612. Region 612 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 602 may provide media guidance data for non-linear programming including on-demand listing 614, recorded content listing 616, and Internet content listing 618. A display combining media guidance data for content from different types of content sources is sometimes referred to as a “mixed-media” display. Various permutations of the types of media guidance data that may be displayed that are different than display 600 may be based on user selection or guidance application definition (e.g., a display of only recorded and broadcast listings, only on-demand and broadcast listings, etc.). As illustrated, listings 614, 616, and 618 are shown as spanning the entire time block displayed in grid 602 to indicate that selection of these listings may provide access to a display dedicated to on-demand listings, recorded listings, or Internet listings, respectively. In some embodiments, listings for these content types may be included directly in grid 602. Additional media guidance data may be displayed in response to the user selecting one of the navigational icons 620. (Pressing an arrow key on a user input device may affect the display in a similar manner as selecting navigational icons 620.)

Display 600 may also include video region 622, and options region 626. Video region 622 may allow the user to view and/or preview programs that are currently available, will be available, or were available to the user. The content of video region 622 may correspond to, or be independent from, one of the listings displayed in grid 602. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 626 may allow the user to access different types of content, media guidance application displays, and/or media guidance application features. Options region 626 may be part of display 600 (and other display screens described herein), or may be invoked by a user by selecting an on-screen option or pressing a dedicated or assignable button on a user input device. The selectable options within options region 626 may concern features related to program listings in grid 602 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 6. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 7. Video mosaic display 700 includes selectable options 702 for content information organized based on content type, genre, and/or other organization criteria. In display 700, television listings option 704 is selected, thus providing listings 706, 708, 710, and 712 as broadcast program listings. In display 700 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 708 may include more than one portion, including media portion 714 and text portion 716. Media portion 714 and/or text portion 716 may be selectable to view content in full-screen or to view information related to the content displayed in media portion 714 (e.g., to view listings for the channel that the video is displayed on).

The listings in display 700 are of different sizes (i.e., listing 706 is larger than listings 708, 710, and 712), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

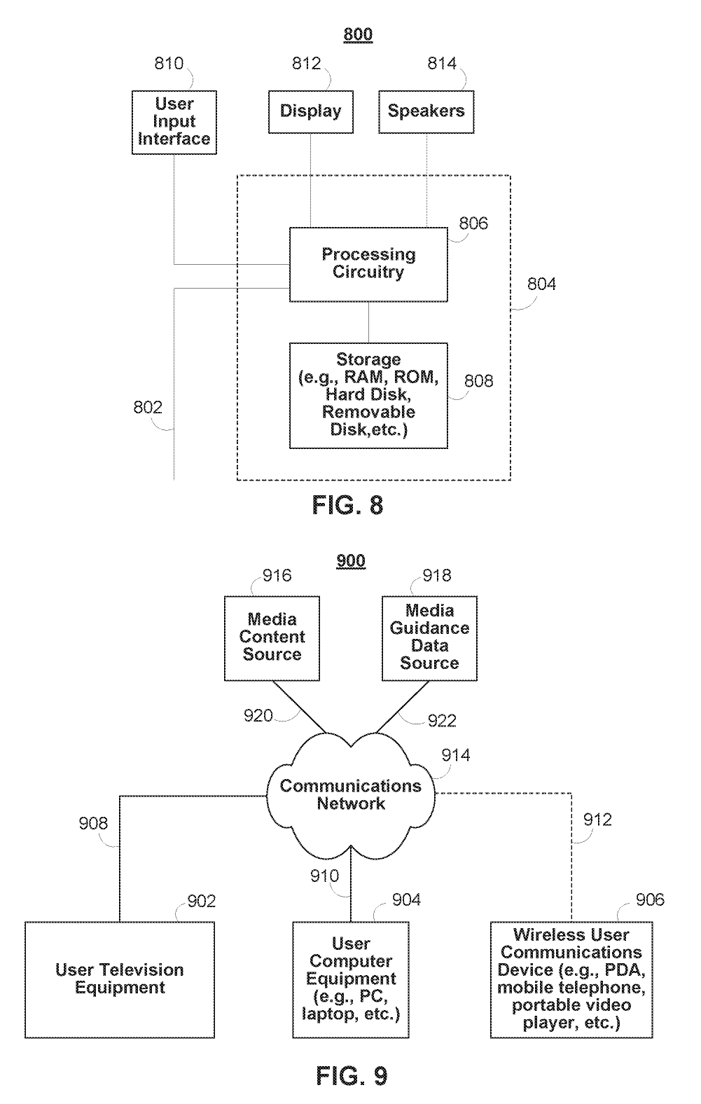

Users may access content and the media guidance application (and its display screens described above and below) from one or more of their user equipment devices. FIG. 8 shows a generalized embodiment of illustrative user equipment device 800. More specific implementations of user equipment devices are discussed below in connection with FIG. 9. User equipment device 800 may receive content and data via input/output (hereinafter “I/O”) path 802. I/O path 802 may provide content (e.g., broadcast programming, on-demand programming, Internet content, content available over a local area network (LAN) or wide area network (WAN), and/or other content) and data to control circuitry 804, which includes processing circuitry 806 and storage 808. Control circuitry 804 may be used to send and receive commands, requests, and other suitable data using I/O path 802. I/O path 802 may connect control circuitry 804 (and specifically processing circuitry 806) to one or more communications paths (described below). I/O functions may be provided by one or more of these communications paths, but are shown as a single path in FIG. 8 to avoid overcomplicating the drawing.

Control circuitry 804 may be based on any suitable processing circuitry such as processing circuitry 806. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 804 executes instructions for a media guidance application stored in memory (i.e., storage 808). Specifically, control circuitry 804 may be instructed by the media guidance application to perform the functions discussed above and below. For example, the media guidance application may provide instructions to control circuitry 804 to generate the media guidance displays. In some implementations, any action performed by control circuitry 804 may be based on instructions received from the media guidance application.

In client-server based embodiments, control circuitry 804 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 9). In addition, communications circuitry may include circuitry that enables peer-to-peer communication of user equipment devices, or communication of user equipment devices in locations remote from each other (described in more detail below).

Memory may be an electronic storage device provided as storage 808 that is part of control circuitry 804. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 808 may be used to store various types of content described herein as well as media guidance data described above. Nonvolatile memory may also be used (e.g., to launch a boot-up routine and other instructions). Cloud-based storage, described in relation to FIG. 9, may be used to supplement storage 808 or instead of storage 808.

Control circuitry 804 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 804 may also include scaler circuitry for upconverting and downconverting content into the preferred output format of the user equipment 800. Circuitry 804 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 808 is provided as a separate device from user equipment 800, the tuning and encoding circuitry (including multiple tuners) may be associated with storage 808.

A user may send instructions to control circuitry 804 using user input interface 810. User input interface 810 may be any suitable user interface, such as a remote control, mouse, trackball, keypad, keyboard, touch screen, touchpad, stylus input, joystick, voice recognition interface, or other user input interfaces. Display 812 may be provided as a stand-alone device or integrated with other elements of user equipment device 800. For example, display 812 may be a touchscreen or touch-sensitive display. In such circumstances, user input interface 810 may be integrated with or combined with display 812. Display 812 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 812 may be HDTV-capable. In some embodiments, display 812 may be a 3D display, and the interactive media guidance application and any suitable content may be displayed in 3D. A video card or graphics card may generate the output to the display 812. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 804. The video card may be integrated with the control circuitry 804. Speakers 814 may be provided as integrated with other elements of user equipment device 800 or may be stand-alone units. The audio component of videos and other content displayed on display 812 may be played through speakers 814. In some embodiments, the audio may be distributed to a receiver (not shown), which processes and outputs the audio via speakers 814.

User input interface 810 may also comprise image recognition hardware, such as a camera or cameras, running suitable image recognition software. The image recognition hardware may be configured to track a user's gaze across display 812. For instance, the user may track the location of the user's eyes and extrapolate a straight line from the user's eyes to the display 812 in order to determine point(s) on the display 812 on which the user's eyes are resting.

The guidance application may be implemented using any suitable architecture. For example, it may be a stand-alone application wholly-implemented on user equipment device 800. In such an approach, instructions of the application are stored locally (e.g., in storage 808), and data for use by the application is downloaded on a periodic basis (e.g., from an out-of-band feed, from an Internet resource, or using another suitable approach). Control circuitry 804 may retrieve instructions of the application from storage 808 and process the instructions to generate any of the displays discussed herein. Based on the processed instructions, control circuitry 804 may determine what action to perform when input is received from input interface 810. For example, movement of a cursor on a display up/down may be indicated by the processed instructions when input interface 810 indicates that an up/down button was selected.

In some embodiments, the media guidance application is a client-server based application. Data for use by a thick or thin client implemented on user equipment device 800 is retrieved on-demand by issuing requests to a server remote to the user equipment device 800. In one example of a client-server based guidance application, control circuitry 804 runs a web browser that interprets web pages provided by a remote server. For example, the remote server may store the instructions for the application in a storage device. The remote server may process the stored instructions using circuitry (e.g., control circuitry 804) and generate the displays discussed above and below. The client device may receive the displays generated by the remote server and may display the content of the displays locally on equipment device 800. This way, the processing of the instructions is performed remotely by the server while the resulting displays are provided locally on equipment device 800. Equipment device 800 may receive inputs from the user via input interface 810 and transmit those inputs to the remote server for processing and generating the corresponding displays. For example, equipment device 800 may transmit a communication to the remote server indicating that an up/down button was selected via input interface 810. The remote server may process instructions in accordance with that input and generate a display of the application corresponding to the input (e.g., a display that moves a cursor up/down). The generated display is then transmitted to equipment device 800 for presentation to the user.

In some embodiments, the media guidance application is downloaded and interpreted or otherwise run by an interpreter or virtual machine (run by control circuitry 804). In some embodiments, the guidance application may be encoded in the ETV Binary Interchange Format (EBIF), received by control circuitry 804 as part of a suitable feed, and interpreted by a user agent running on control circuitry 804. For example, the guidance application may be an EBIF application. In some embodiments, the guidance application may be defined by a series of JAVA-based files that are received and run by a local virtual machine or other suitable middleware executed by control circuitry 804. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 800 of FIG. 8 can be implemented in system 900 of FIG. 9 as user television equipment 902, user computer equipment 904, wireless user communications device 906, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 8 may not be classified solely as user television equipment 902, user computer equipment 904, or a wireless user communications device 906. For example, user television equipment 902 may, like some user computer equipment 904, be Internet-enabled allowing for access to Internet content, while user computer equipment 904 may, like some television equipment 902, include a tuner allowing for access to television programming. The media guidance application may have the same layout on various different types of user equipment or may be tailored to the display capabilities of the user equipment. For example, on user computer equipment 904, the guidance application may be provided as a web site accessed by a web browser. In another example, the guidance application may be scaled down for wireless user communications devices 906.

In system 900, there is typically more than one of each type of user equipment device but only one of each is shown in FIG. 9 to avoid overcomplicating the drawing. In addition, each user may utilize more than one type of user equipment device and also more than one of each type of user equipment device.

In some embodiments, a user equipment device (e.g., user television equipment 902, user computer equipment 904, wireless user communications device 906) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 914. Namely, user television equipment 902, user computer equipment 904, and wireless user communications device 906 are coupled to communications network 914 via communications paths 908, 910, and 912, respectively. Communications network 914 may be one or more networks including the Internet, a mobile phone network, mobile voice or data network (e.g., a 4G or LTE network), cable network, public switched telephone network, or other types of communications network or combinations of communications networks. Paths 908, 910, and 912 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 912 is drawn with dotted lines to indicate that in the exemplary embodiment shown in FIG. 9 it is a wireless path and paths 908 and 910 are drawn as solid lines to indicate they are wired paths (although these paths may be wireless paths, if desired). Communications with the user equipment devices may be provided by one or more of these communications paths, but are shown as a single path in FIG. 9 to avoid overcomplicating the drawing.

Although communications paths are not drawn between user equipment devices, these devices may communicate directly with each other via communication paths, such as those described above in connection with paths 908, 910, and 912, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 914.

System 900 includes content source 916 and media guidance data source 918 coupled to communications network 914 via communication paths 920 and 922, respectively. Paths 920 and 922 may include any of the communication paths described above in connection with paths 908, 910, and 912. Communications with the content source 916 and media guidance data source 918 may be exchanged over one or more communications paths, but are shown as a single path in FIG. 9 to avoid overcomplicating the drawing. In addition, there may be more than one of each of content source 916 and media guidance data source 918, but only one of each is shown in FIG. 9 to avoid overcomplicating the drawing. (The different types of each of these sources are discussed below.) If desired, content source 916 and media guidance data source 918 may be integrated as one source device. Although communications between sources 916 and 918 with user equipment devices 902, 904, and 906 are shown as through communications network 914, in some embodiments, sources 916 and 918 may communicate directly with user equipment devices 902, 904, and 906 via communication paths (not shown) such as those described above in connection with paths 908, 910, and 912.

Content source 916 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 916 may be the originator of content (e.g., a television broadcaster, a Webcast provider, etc.) or may not be the originator of content (e.g., an on-demand content provider, an Internet provider of content of broadcast programs for downloading, etc.). Content source 916 may include cable sources, satellite providers, on-demand providers, Internet providers, over-the-top content providers, or other providers of content. Content source 916 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 918 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 918 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 918 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 918 may provide user equipment devices 902, 904, and 906 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 808, and executed by control circuitry 804 of a user equipment device 800. In some embodiments, media guidance applications may be client-server applications where only a client application resides on the user equipment device, and server application resides on a remote server. For example, media guidance applications may be implemented partially as a client application on control circuitry 804 of user equipment device 800 and partially on a remote server as a server application (e.g., media guidance data source 918) running on control circuitry of the remote server. When executed by control circuitry of the remote server (such as media guidance data source 918), the media guidance application may instruct the control circuitry to generate the guidance application displays and transmit the generated displays to the user equipment devices. The server application may instruct the control circuitry of the media guidance data source 918 to transmit data for storage on the user equipment. The client application may instruct control circuitry of the receiving user equipment to generate the guidance application displays.

Content and/or media guidance data delivered to user equipment devices 902, 904, and 906 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 900 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 9.

In one approach, user equipment devices may communicate with each other within a home network.

User equipment devices can communicate with each other directly via short-range point-to-point communication schemes described above, via indirect paths through a hub or other similar device provided on a home network, or via communications network 914. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 916 to access content. Specifically, within a home, users of user television equipment 902 and user computer equipment 904 may access the media guidance application to navigate among and locate desirable content. Users may also access the media guidance application outside of the home using wireless user communications devices 906 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 914. These cloud resources may include one or more content sources 916 and one or more media guidance data sources 918. In addition or in the alternative, the remote computing sites may include other user equipment devices, such as user television equipment 902, user computer equipment 904, and wireless user communications device 906. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 904 or wireless user communications device 906 having content capture feature. Alternatively, the user can first transfer the content to a user equipment device, such as user computer equipment 904. The user equipment device storing the content uploads the content to the cloud using a data transmission service on communications network 914. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 8.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

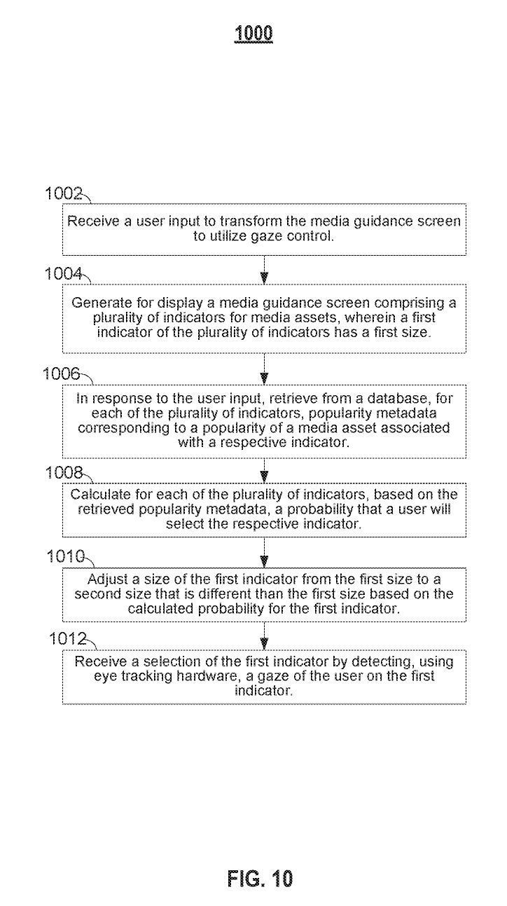

FIG. 10 is a flowchart 1000 of illustrative steps for navigating a media guidance application using gaze control in accordance with some embodiments of the disclosure. It should be noted that process 1000, or any step thereof, could occur on, or be provided by, any of the devices shown in FIGS. 8-9. For example, process 1000 may be executed by control circuitry 804 (FIG. 8) as instructed by the media guidance application (e.g., as implemented on any of the devices shown and described in FIG. 9).

At step 1002, the media guidance application may receive (e.g., using user input interface 810 and control circuitry 804), a user input to transform the media guidance screen to utilize gaze control. The user input may be any suitable user input, including, but not limited to, a voice command, a button press or presses on a remote control, keyboard, or other user input device, or a physical gesture.

At step 1004, the media guidance application may generate for display (e.g., on display 812) a media guidance screen comprising a plurality of indicators for media assets, wherein a first indicator of the plurality of indicators has a first size. For instance, the media guidance screen may generate for display a grid guide, as depicted in FIG. 6.

At step 1006, in response to the user input to transform the media guidance screen to utilize gaze control, the media guidance application may retrieve (e.g., using control circuitry 804) from a database (such as media guidance data source 918), for each of the plurality of indicators, popularity metadata corresponding to a popularity of a media asset associated with a respective indicator. As described above, the popularity metadata may include any suitable data associated with media assets or media guidance options that may be used to calculate a probability that the user will select the media asset or media guidance option. For example, the popularity metadata may include one or more of the following: ratings data from the user or from a third party, media asset viewing history of the user, media asset viewing history of a plurality of users, and media asset preferences of the user. In some embodiments, the media guidance application may access several databases to retrieve the popularity metadata. For example, the media guidance application may access a first database to retrieve popularity metadata for a first subset of the indicators, and may access a second database to retrieve popularity metadata for a second subset of the indicators. In some embodiments, the media guidance application may access certain types of popularity metadata from a first database and other types of popularity metadata from a second database. For instance, the media guidance application may retrieve critic ratings from a website server and a user profile indicating the user's media preferences from local storage (such as storage 808) on a user device.

At step 1008, the media guidance application may calculate (e.g., using control circuitry 804), for each of the plurality of indicators, based on the retrieved popularity metadata, a probability that a user will select the respective indicator. The probability may be represented in any suitable manner, including as a numerical score, a percentage, a star system (e.g., 0 to 5 stars), binary system (e.g., thumbs up or thumbs down) or any other suitable manner. In some embodiments, the media guidance application may divide the popularity metadata into one or more components and calculate a numerical component score for each component. The components may include, but are not limited to, prior viewing history and selections, third-party ratings data, user preferences, user ratings and feedback data, and social media indicators. The media guidance application may calculate the numerical component scores by, for example, assigning points to certain data that are indicated in the popularity metadata and summing the points to determine the component score. For example, the media guidance application may assign a certain number of points to media assets that the user has previously viewed, set a reminder, set a recording, or requested further information for. As another example, the media guidance application may retrieve a critic rating as a percentage score from a remote database (such as a website) and assign the retrieved percentage score as the component score for the component “third-party ratings.” In some embodiments, the media guidance application may access a social network profile associated with the user and identify other members of the social network that are associated with the user, such as “friends” of the user. The media guidance application may retrieve interactions of these other members with media assets and assign a certain number of points to these interactions. For example, the media guidance application may assign a certain number of points to media assets the user's friends have viewed, set a reminder, set a recording, requested further information for, added the media asset to a “favorites” list, or indicated that they “like” the media asset.

In some embodiments, the media guidance application may access (e.g., from storage 808 or media guidance data source 918) a user profile associated with the user that indicates media preferences of the user. The media guidance may assign points to any indicator for a media asset that is preferred by the user according to his or her media preferences. For instance, the media preferences may indicate a user's “favorite” media assets or genres or categories. For each indicator associated with one of the user's favorite media assets, genres, or categories, the media guidance asset may assign a certain number of points. In some embodiments, the media guidance application may generate for display one or more indicators corresponding to one or more of the user's favorite genres or categories. For example, as depicted in FIG. 1, the media guidance application may generate for display an indicator for “movies” if the user has indicated in his or her profile that he or she prefers to watch movies over other program types.

In some embodiments, the media guidance may tally each of the points accrued in each of the components to generate a plurality of component scores. The media guidance application may combine these component scores using any suitable calculation, such as an average or weighted average in order to output a total percentage that represents a likelihood that the user will select the respective indicator. Before combining the component scores, the media guidance application may normalize each of the component scores. For example, the media guidance application may sum the component scores and divide each component score by the sum in order to obtain normalized component scores.

At step 1010, the media guidance application may adjust a size of the first indicator from a first size to a second size that is different than the first size based on the calculated probability for the indicator. For example, the media guidance application may determine that the first indicator has a relatively high probability of being selected, compared to the other displayed indicators. The media guidance application may increase the size of the first indicator to reflect this relatively high probability. In some embodiments, the media guidance application may also relocate the indicator closer to the center of the generated display to make the indicator easier to select using gaze control.

At step 1012, the media guidance application may receive (e.g., using control circuitry 804 and user input interface 810) a selection of the first indicator by detecting, using eye tracking hardware, a gaze of the user on the first indicator. As described above, the media guidance application may receive the user selection in any number of ways. In some embodiments, the media guidance application may receive the user selection by detecting that the user's gaze has rested on the indicator for a certain period of time. In some embodiments, the media guidance application may receive the user selection by detecting the user's gaze on an indicator in conjunction with a secondary input, such as a voice command or a button press on a user input device (such as a remote control or a keyboard).

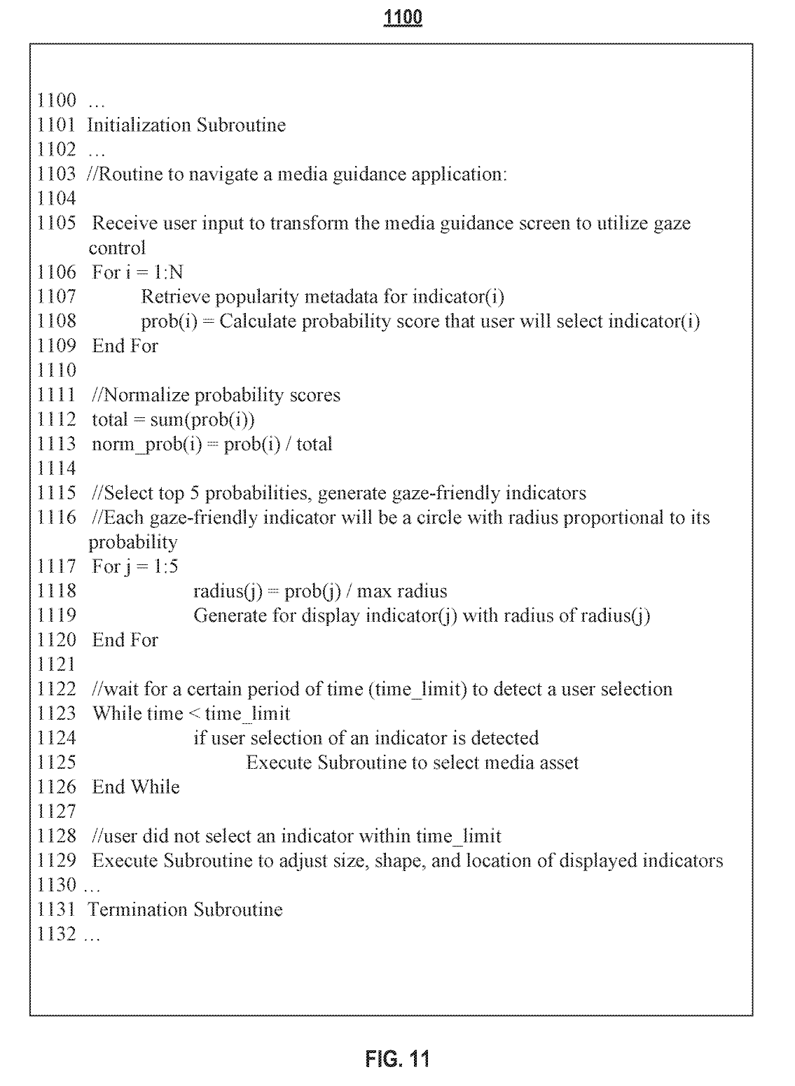

FIG. 11 depicts illustrative pseudocode 1100 for utilizing gaze control in a media guidance application in accordance with some embodiments of the disclosure. It will be evident to one skilled in the art that the process described by the pseudocode in

FIG. 11 may be implemented in any number of programming languages and a variety of different hardware, and that the style and format should not be construed as limiting, but rather a general template of the steps and procedures that would be consistent with code used to implement some embodiments of this disclosure.

At line 1101, control circuitry 804 runs a subroutine to initialize variables and prepare to implement gaze control, which begins on line 1103. For example, in some embodiments control circuitry 804 may copy instructions from non-transitory storage medium (e.g., storage 808) into RAM or into the cache for processing circuitry 806 during the initialization stage.

At line 1105, the control circuitry 804 may receive a user input to transform the media guidance screen to utilize gaze control. As described above, the received user input may be any suitable user input, such as a voice command or a button press on a user input device. At lines 1106 to 1109, the control circuitry 804 may retrieve popularity metadata for each of the indicators and calculate a probability score that the user will select the respective indicator. Although lines 1106 to 1109 are depicted as a single loop, it will be understood that several loops may be run in parallel to retrieve the popularity metadata for each of the indicators and to calculate the respective probabilities. The control circuitry 804 may calculate the probabilities as discussed above in conjunction with step 1008 of FIG. 10 and store the result in an array named “prob.”

At lines 1111-1113, the control circuitry 804 may normalize the probability scores. For example, the control circuitry 804 may calculate the sum of all of the probabilities and store it in a temporary variable named “total.” The control circuitry 804 may then divide each of the probability scores by the “total” and store the result in an array named “norm_prob.”

At lines 1115-1120, the control circuitry 804 may generate for display a gaze-friendly indicator for the top five indicators, with each gaze-friendly indicator being a circle with a radius proportional to its probability. At line 1118, the control circuitry 804 may calculate a radius for each of the top five indicators by dividing the calculated probability of the indicator, as stored in the variable “prob,” by a constant called “max radius.” The constant “max radius” may represent the largest possible radius that an indicator can achieve—that is, the radius of an indicator if it had a theoretical 100% probability of being selected by the user. At line 1119, the control circuitry 804 may generate for display the indicator with the calculated radius. Although lines 1117 to 1120 are depicted as a single loop, it will be understood that several loops may be run in parallel to calculate the radius of the indicators and to generate for display the indicators.

At lines 1122-1126, the control circuitry 804 may wait for a certain period of time to detect a user selection. For example, the control circuitry 804 may wait for a certain period of time named “time_limit” to detect a selection of the indicator. As described above, the user selection may be received in any suitable manner, including by detecting the user's gaze on the indicator and/or detecting the user's gaze in conjunction with a secondary input such as a voice command or a button press on a user input device. If the user selection of the indicator is detected, then the control circuitry 804 may execute a subroutine to select the media asset at line 1125. This subroutine may include any actions that are typically performed upon selection of a media asset listing or media guidance option. For example, if the indicator is a listing for a media asset, then the subroutine to select the media asset may include providing further information about the media asset, viewing the media asset, accessing a media content delivery service that provides the media asset, or providing an option to set a reminder/record/order for the media asset, among others. If the indicator is a media guidance option, then the subroutine may include executing the media guidance option.

At line 1129, if the user did not select the indicator within the time limit, then the control circuitry 804 may execute a subroutine to adjust the size, shape, and/or location of the displayed indicators. For example, as discussed above, the gaze-control mode may be dynamically changed as time elapses such that the displayed indicators increase and decrease in size and are relocated on the displayed screen over time.

At line 1131, the control circuitry 804 runs a termination subroutine after the algorithm has performed its function. For example, in some embodiments control circuitry 804 may destruct variables, perform garbage collection, free memory or clear the cache of processing circuitry 806.

It will be evident to one skilled in the art that process 1100 described by the pseudocode in FIG. 11 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments break conditions may be placed throughout to speed operation, or the conditional statements may be replaced with a case-switch. In some embodiments, rather than iterating over all instances of a variable, in some embodiments the code may be rewritten so control circuitry 804 is instructed to evaluate multiple instances simultaneously on a plurality of processors or processor threads, lowering the number of iterations needed and potentially speeding up computation time.

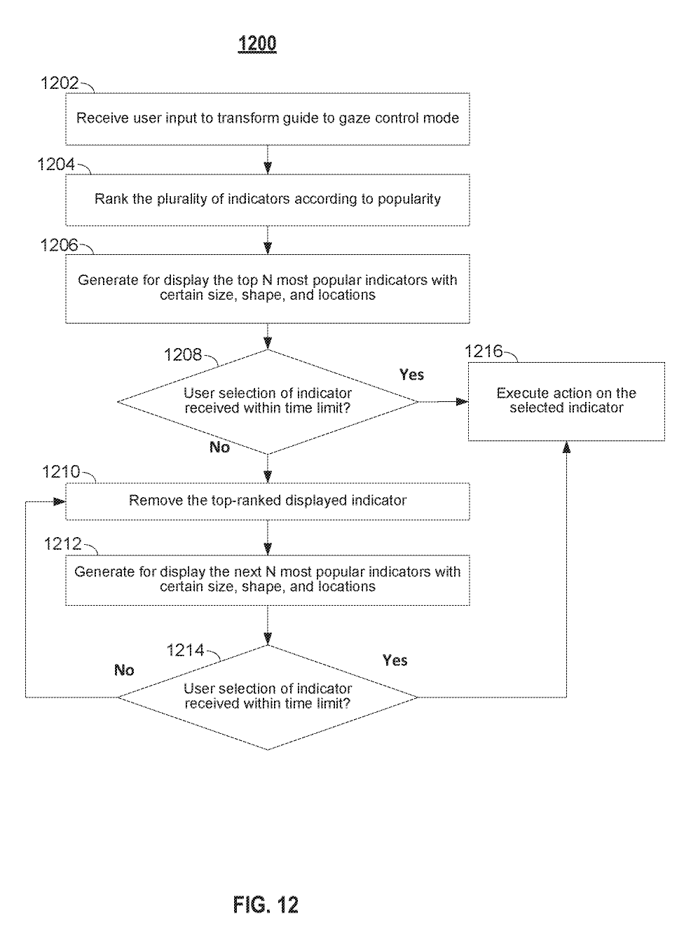

FIG. 12 is a flowchart 1200 of illustrative steps for navigating a media guidance application using gaze control in accordance with some embodiments of the disclosure. It should be noted that process 1200, or any step thereof, could occur on, or be provided by, any of the devices shown in FIGS. 8-9. For example, process 1200 may be executed by control circuitry 804 (FIG. 8) as instructed by the media guidance application (e.g., as implemented on any of the devices shown and described in FIG. 9).

At step 1202, the media guidance application may receive (e.g., using control circuitry 804) a user input to transform the guide to gaze control mode. Step 1202 may be substantially similar to step 1002 described above in relation to FIG. 10. At step 1204, the media guidance application may rank the plurality of indicators according to popularity. For example, the media guidance application may calculate, for each of the displayed indicators, a probability that the user will select the respective indicator according to the method discussed in relation to step 1008 of FIG. 10. The media guidance application may then sort the indicators from highest probability to lowest probability.

At step 1206, the media guidance application may generate for display (e.g., on display 812) the top N most popular indicators with certain size, shape, and locations. N may be any predetermined constant and may be set according to user preferences. For instance, the media guidance application may generate for display the top five indicators on a media guidance screen. As discussed above, the indicators may be depicted as circles with a radius that is proportional to their respective probabilities, with higher-probability indicators located towards the center of the display and lower-probability indicators located toward the periphery of the display.

At step 1208, the media guidance application may determine (e.g., using control circuitry 804 and user input interface 810), whether a user selection of an indicator has been received within a time limit. As discussed above, the user selection may be received in any suitable manner. In some embodiments, the media guidance application may detect whether a user's gaze has rested on an indicator for a certain period of time. In some embodiments, the media guidance application may determine whether the user's gaze is on an indicator while a secondary input is received, such as a voice command or a button press on a user input device. If the user selection is received within the time limit, then the media guidance application may execute an action on the selected indicator at step 1216. For example, if the indicator is a listing for a media asset, then the media guidance application may perform one or more actions on the corresponding media asset, such as provide further information about the media asset, view the media asset, access a media content delivery service that provides the media asset, or provide an option to set a reminder/record/order for the media asset, among others. If the indicator is a media guidance option, then the media guidance application may execute the media guidance option. For example, if the indicator is “weather,” then the media guidance application may access a data source that provides weather information and generate the weather information on the display.

If a user selection is not received within the time limit, then the media guidance application may remove the top-ranked displayed indicator from the displayed media guidance screen at step 1210. In some embodiments, the top-ranked indicator may be removed gradually. For example, the radius of the top-ranked indicator may be reduced over time until it reaches zero. In some embodiments, the top-ranked indicator may be removed at once with no reduction in size. At step 1212, the media guidance application may generate for display the next N most popular indicators with certain size, shape, and locations. For example, after removing the top-ranked displayed indicator, the media guidance application may select indicators ranked second through N+1 for display on the media guidance screen. In some embodiments, the media guidance application may adjust the size, shape, and location of the displayed indicators. For instance, with the top-ranked indicator removed, the indicator ranked second is now the highest probability indicator on the display screen, and thus may be depicted near the center of the display screen in a space that was previously occupied by the top-ranked indicator. Similarly, the size, shape, and location of the other displayed indicators may be recalibrated according to their calculated probabilities, taking into account the removal of the top-ranked indicator.

At step 1214, the media guidance application may detect whether another user selection is received within a time limit. Step 1214 may be substantially similar to step 1208, described above. If the user selection is received within the time limit, then the media guidance application may execute an action on the selected indicator at step 1216. If the user selection is not received within the time limit, then the media guidance application may return to step 1210 and remove the top-ranked displayed indicator. For example, the media guidance application may remove the indicator ranked second overall and select the indicators ranked third to N+2 for display. In this manner, the media guidance application may cycle through the indicators according to their rank while always displaying N indicators.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for navigating a media guidance application, the method comprising:
receiving a user input to transform the media guidance screen to utilize gaze control;
generating for display a media guidance screen comprising a plurality of indicators for media assets, wherein a first indicator of the plurality of indicators has a first size;
in response to the user input:
retrieving from a database, for each of the plurality of indicators, popularity metadata corresponding to a popularity of a media asset associated with a respective indicator;
calculating for each of the plurality of indicators, based on the retrieved popularity metadata, a probability that a user will select the respective indicator;
adjusting a size of the first indicator from the first size to a second size that is different than the first size based on the calculated probability for the first indicator; and
receiving a selection of the first indicator by detecting, using eye tracking hardware, a gaze of the user on the first indicator.

2. The method of claim 1, wherein receiving the selection of the first indicator comprises:
detecting the gaze of the user on the first indicator;
subsequent to detecting the gaze of the user on the first indicator, determining a period of time has passed; and
in response to the period of time passing, selecting the first indicator.

3. The method of claim 1, wherein receiving the selection of the selection of the first indicator comprises:
detecting the gaze of the user on the first indicator;
subsequent to detecting the gaze of the user on the first indicator, receiving a voice command while the gaze of the user is on the first indicator; and
in response to the voice command, selecting the first indicator.

4. The method of claim 1, wherein the first indicator has a first shape, and wherein in response to the user input, a shape of the first indicator is changed from the first shape to a second shape that is different from the first shape.

5. The method of claim 1, wherein the first indicator is located at a first position on a display screen, and wherein in response to the user input, the first indicator is generated for display at a second position on the display screen that is different than the first position.

6. The method of claim 1, further comprising:
tracking the gaze of the user using the eye tracking hardware;
determining that the gaze of the user has not stayed on one of the plurality of indicators for a period of time;
in response to determining that the gaze of the user has not stayed on one of the plurality of indicators for the period of time, adjusting the size of the first indicator from the second size to a third size that is different than the second size.

7. The method of claim 6, further comprising, in response to determining that the gaze of the user has not stayed on one of the plurality of indicators for the period of time, moving the first indicator from a first position on a display screen to a second position on the display screen.

8. The method of claim 1, further comprising determining, based on the calculated probabilities, that the first indicator corresponds to a media asset that has the highest probability of being selected by the user.

9. The method of claim 1, wherein the popularity metadata includes one or more of the following: ratings data from the user or from a third party, media asset viewing history of the user, media asset viewing history of a plurality of users, and media asset preferences of the user.

10. The method of claim 1, wherein calculating the probability that a user will select the respective indicator comprises:
transforming the popularity metadata into a numerical indicator of the popularity of the media asset associated with the respective indicator; and
normalizing the numerical indicators for the plurality of indicators by summing the numerical indicators and dividing each numerical indicator by the calculated sum.

11. A system for navigating a media guidance application, the system comprising:
control circuitry configured to:
receive a user input to transform the media guidance screen to utilize gaze control;
generate for display a media guidance screen comprising a plurality of indicators for media assets, wherein a first indicator of the plurality of indicators has a first size;
in response to the user input:
retrieve from a database, for each of the plurality of indicators, popularity metadata corresponding to a popularity of a media asset associated with a respective indicator;
calculate for each of the plurality of indicators, based on the retrieved popularity metadata, a probability that a user will select the respective indicator;
adjust a size of the first indicator from the first size to a second size that is different than the first size based on the calculated probability for the first indicator; and
receive a selection of the first indicator by detecting, using eye tracking hardware, a gaze of the user on the first indicator.

12. The system of claim 11, wherein the control circuitry is configured to receive the selection of the first indicator by:
detecting the gaze of the user on the first indicator;
subsequent to detecting the gaze of the user on the first indicator, determining a period of time has passed; and
in response to the period of time passing, selecting the first indicator.

13. The system of claim 11, wherein the control circuitry is configured to receive the selection of the first indicator by:
detecting the gaze of the user on the first indicator;
subsequent to detecting the gaze of the user on the first indicator, receiving a voice command while the gaze of the user is on the first indicator; and
in response to the voice command, selecting the first indicator.

14. The system of claim 11, wherein the first indicator has a first shape, and wherein in response to the user input, a shape of the first indicator is changed from the first shape to a second shape that is different from the first shape.

15. The system of claim 11, wherein the first indicator is located at a first position on a display screen, and wherein in response to the user input, the first indicator is generated for display at a second position on the display screen that is different than the first position.

16. The system of claim 11, wherein the control circuitry is further configured to:
track the gaze of the user using the eye tracking hardware;
determine that the gaze of the user has not stayed on one of the plurality of indicators for a period of time;
in response to determining that the gaze of the user has not stayed on one of the plurality of indicators for the period of time, adjust the size of the first indicator from the second size to a third size that is different than the second size.

17. The system of claim 16, wherein the control circuitry is further configured to, in response to determining that the gaze of the user has not stayed on one of the plurality of indicators for the period of time, move the first indicator from a first position on a display screen to a second position on the display screen.

18. The system of claim 11, wherein the control circuitry is further configured to determine, based on the calculated probabilities, that the first indicator corresponds to a media asset that has the highest probability of being selected by the user.

19. The system of claim 11, wherein the popularity metadata includes one or more of the following: ratings data from the user or from a third party, media asset viewing history of the user, media asset viewing history of a plurality of users, and media asset preferences of the user.

20. The system of claim 11, wherein the control circuitry is configured to calculate the probability that a user will select the respective indicator by:
transforming the popularity metadata into a numerical indicator of the popularity of the media asset associated with the respective indicator; and
normalizing the numerical indicators for the plurality of indicators by summing the numerical indicators and dividing each numerical indicator by the calculated sum.

21-50. (canceled)
